(19) United States
(12) Patent Application Publication
(10) Pub. No.: US 2026/0153167 A1
(43) Pub. Date: Jun. 4, 2026

(54) A PIPING SADDLE BRACKET

(71) Applicant: VENTRIX TECHNICAL SERVICES PTY LTD, Rockdale (AU)

(72) Inventor: Andrew Markopoulos, Rockdale (AU)

(21) Appl. No.: 18/832,450

(22) PCT Filed: Dec. 1, 2023
(86) PCT No.: PCT/AU2023/051238

§ 371 Date: Jul. 23, 2024

(30) Foreign Application Priority Data
Dec. 16, 2022 (AU) 2022903878

(51) Int. Cl. F16L 3/26; F16B 7/04

(52) U.S. Cl. CPC F16L 3/26; F16B 7/0433

(57) ABSTRACT

The piping saddle bracket described is designed for versatile installation in comprising a pipe channel forming portion which establishes an open pipe channel between the bracket's ends that accommodates piping and addressing insulation issues and a cross-strut channel forming portion under the pipe channel that includes suspension rod connection tabs on both sides, enabling engagement with suspension rods. The bracket allows flexible installation configurations, either supported by a cross strut or suspension rods, and can be vertically stacked for space-saving arrangements. The bracket is preferably designed to accommodate more than one pipe adjacently.

### FIELD OF THE INVENTION

This invention relates to a piping saddle bracket designed for versatile suspended pipework installations.

### BACKGROUND OF THE INVENTION

Piping for services is hung from overhead ceiling structures using metallic cross-struts supported by suspension rods at their ends.

This configuration positions the pipework on the upper surface of the suspended cross-struts.

However, insulation, typically in the form of a closed-cell insulating material tubular sheath, is often necessary for heating or cooling piping. Unfortunately, the pressure exerted by the narrow upper edges of the cross-struts tends to compress this insulation, diminishing its effectiveness.

As such, cross-struts are often installed upside down so that their flat edges interface the piping as opposed to the channel edges thereof. For example, US 20200300386 A1 (Dodge et al.) 24 Sep. 2020 discloses pipe support which has body forming a generally arcuate bottom floor and a pair of spaced apart sidewalls projecting generally upwardly from the bottom floor. A plurality of axially spaced apart channel clips project downwardly from the outer surface of the body portion opposite the side walls. As such, the channel clips engage the channels strut directly whereby the generally arcuate bottom floor increases the surface area thereacross for a pipe.

The present invention seeks to provide a piping saddle bracket, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

Described herein is a piping saddle bracket featuring a pipe channel forming portion, comprised of a base and sides that effectively establish an open pipe channel between the bracket's ends, designed to accommodate piping.

Additionally, the bracket includes a cross-strut channel forming portion defining a cross-strut channel beneath and across the pipe channel. The cross-strut channel forming portion also forms suspension rod connection tabs on both sides of the pipe channel, strategically arranged to engage a respective pair of suspension rods during usage.

The open pipe channel addresses impingement issues related to piping insulating sheaths.

Furthermore, the bracket allows for versatile installation, either supported by a cross strut alone or suspension rods with or without a cross strut. In another configuration, multiple brackets can be vertically stacked in a space-saving arrangement, engaged by a pair of common suspension rods. Vertical offset between brackets can vary to accommodate different diameters of piping engaged by each bracket.

Each suspension rod connection tab may feature an insertion slot facilitating sideways connection of the suspension rods, complemented by a washer recess intersecting the slot to prevent lateral disengagement of the suspension rod. In certain embodiments, the bracket may have a central suspension rod connection aperture through the base of the pipe channel forming portion, enabling installation with a central suspension rod only or a combination of a central and side suspension rods or a central suspension rod and cross-strut to enhance weight-carrying capacity.

The base may include multiple central suspension rod connection apertures, offering flexibility in lateral positioning of the central suspension rod, especially useful when the central suspension rod is between differently sized pipes. The plurality of suspension rod connection apertures may feature washer recesses to secure the central suspension rod's position.

In some embodiments, the suspension rod connection tabs are recessed within vertical passageways bisecting the sides in the top cross-section. This design facilitates stacking of brackets. Furthermore, this design allows side suspension rods to be positioned close to the sides of the pipe channel and facilitates a space-saving configuration where multiple brackets can be placed adjacently with interlocking sides. Connection tabs of adjacent brackets may be connected using a specialised connector in certain embodiments.

The preferred design of the pipe channel allows fitting more than one pipe adjacently, featuring a planar surface or a pipe channel having a wight twice its depth or more to accommodate multiple pipes. The pipe channel forming portion may defines a curvature with a radius between the base and each side, where the width between the sides is four times the radius or more so that adjacent pipes can nestle in each corner of the pipe channel.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a top perspective view of a piping saddle bracket;

FIG. 2 shows an underside perspective view of the bracket;

FIG. 3 shows a top plan view of the bracket;

FIG. 4 shows a bottom plan view of the bracket;

FIG. 5 shows a side view of the bracket;

FIG. 6 shows an end view of the bracket;

FIG. 7 shows a top perspective view of a wider bracket in accordance with an embodiment;

FIG. 8 shows a bottom perspective view of the wider bracket of FIG. 7;

FIGS. 9 and 10 illustrates the direct connections of the bracket to a pair of suspension rods in one configuration;

FIGS. 11 and 12 illustrate the direct connections of the bracket to a central suspension rod in a further configuration;

FIGS. 13 and 14 illustrate the suspension of the bracket both from a pair of suspension rods and a cross reinforcing cross-strut in a further configuration;

FIG. 15 shows a top perspective view of a connector for connecting adjacent brackets in an embodiment;

FIG. 16 shows an underside perspective view of the connector;

FIGS. 17 and 18 illustrate compact stacking of brackets and a further configuration;

FIGS. 19 and 20 illustrate a side-by-side configuration of brackets; and

FIGS. 21 and 22 show a vertically offset configuration of brackets.

### DESCRIPTION OF EMBODIMENTS

A piping saddle bracket 100 has a pipe channel forming portion 101 having a base 102 and sides 103 forming an open pipe channel 104 (best seen in FIG. 6) between ends of the bracket 100. The base 102 has a length along the pipe channel which is wider than a cross strut, thereby addressing pipe impingement.

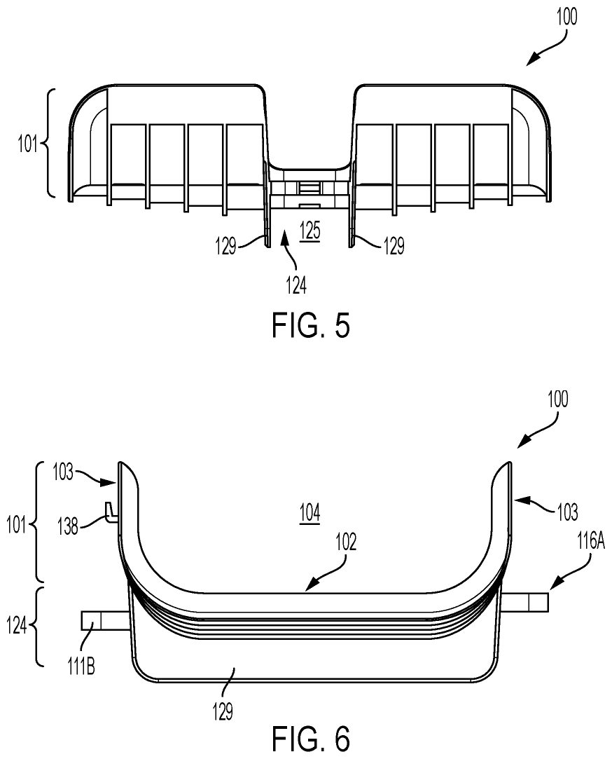

For orientational referencing, FIG. 6 shows an end view of the bracket and FIG. 5 shows a side view of the bracket 100.

In a preferred embodiment the pipe channel 104 is configured to fit more than one pipe adjacently therealong.

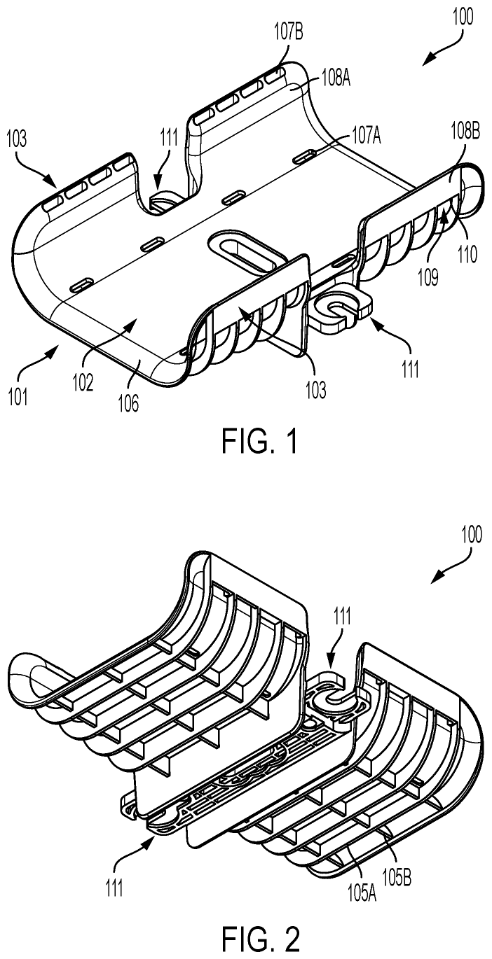

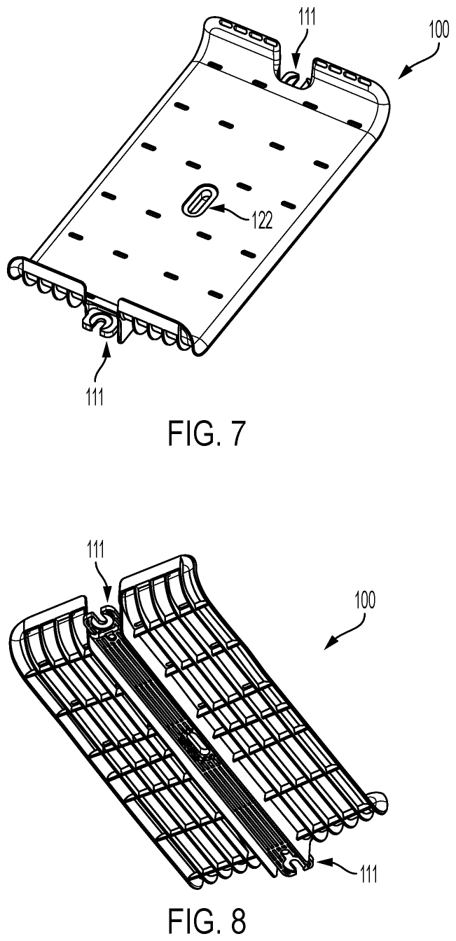

As is shown in FIG. 6, the pipe channel 104 may have a width twice its depth or more. The width of the bracket 100 may vary depending on the pipework carrying capacity thereof. For example, the embodiment shown in FIGS. 1-6 may be suited for accommodating a pair of parallel adjacent pipes along the base 102 whereas the wider embodiment of FIGS. 7-8 may be configured for accommodating more than two pipes.

As shown in FIG. 6, the base 102 may define a planar upper surface to accommodate multiple pipes thereacross. As is also shown in FIG. 6, the pipe channel forming portion 101 may define a curvature having a radius between the base 102 and the sides 103 and wherein a width between the sides 103 is four times the radius or more. As such, adjacent pipes may nestle in respective semicylindrical corners of the pipe channel 104.

The bracket 100 may be made of plastic and may be made integrally as a single part from an injection moulding process.

The base 102 may be strengthened by an orthogonal arrangement of strengthening ribs 105 having a cross strengthening ribs 105A and longitudinal strengthening ribs 105B.

Ends of the bracket 100 may have outward flaring 106 shown in FIG. 1 to avoid sharp edge impingement.

The bracket 100 may have a configuration of cable tie accommodating apertures 107 through which cable ties may be looped to hold pipes within the pipe channel 104. With reference to FIG. 1, the bracket 100 may comprise base cable tie accommodating apertures 107A generally arranged either side of the base 102 of the pipe channel forming portion 101 and side cable tie accommodating apertures 107B through upper edges of the sides 103 of the pipe channel forming portion 101.

The side cable tie accommodating apertures 107B may lead into interior channels 109 formed between an inner side wall 108A and an outer side wall 108B. Beneath the outer side wall 108B, each channel 109 may continue between respective pairs of cross strengthening ribs 105A.

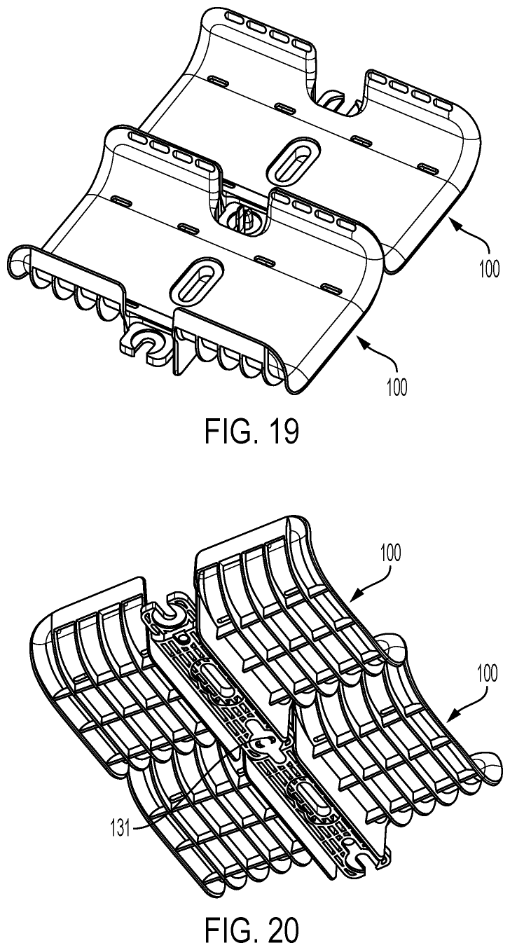

As will be described in further detail below, lower edges 110 of the outer side wall 108B may form a female engagement to engage a male engagement 138 for connecting adjacent brackets 100 together as is shown in FIGS. 19 and 20.

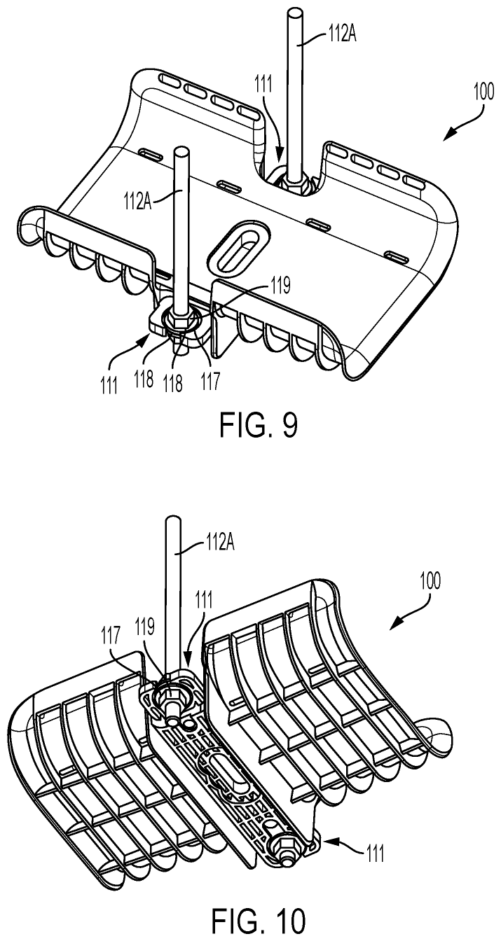

With reference to FIG. 5, the bracket 100 further comprises a cross-strut channel forming portion 124 defining a cross-strut channel 125 across and under the pipe channel 104. The cross-strut channel forming portion further defines suspension rod connection tabs 111 on both sides of the pipe channel 104 configured to engage a respective pair of suspension rods 112A as is shown in FIGS. 9 and 10 to suspend the bracket 100 from an overhead structure, such as a ceiling slab or the like.

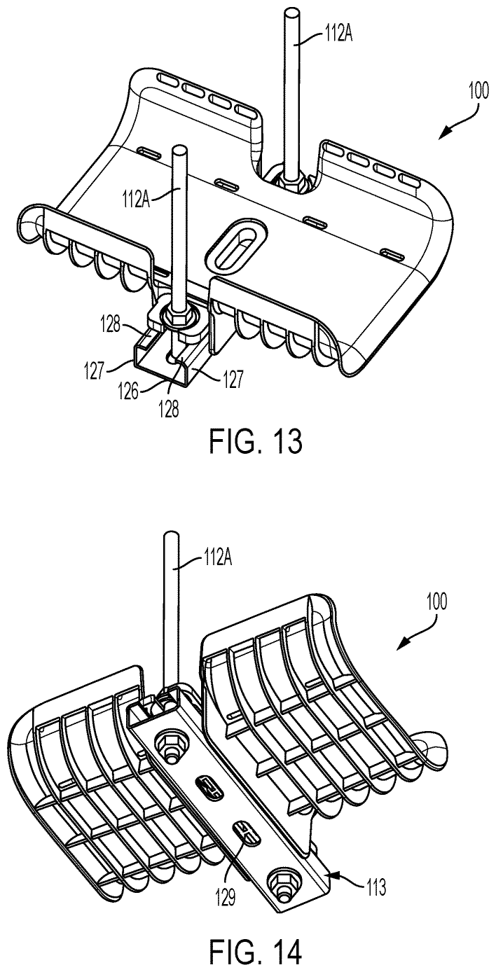

According to the configuration shown in FIGS. 9 and 10, the bracket 100 is connected directly to the suspension rods 112A and supported solely by the lateral suspension 112A. In other words, according to the configuration shown in FIGS. 9 and 10, the bracket 100 is not supported by a cross-strut 113 between the suspension rods 112A. However, as will be described in further detail below with reference to the configuration shown in FIGS. 13 and 14, the bracket 100 may be configured for the alternative configuration wherein suspension rods 112A connect both to the suspension rod connection tabs 111 and a cross-strut 113 therebetween or where the bracket 100 is connected only to the cross strut 113 without suspension rods 112.

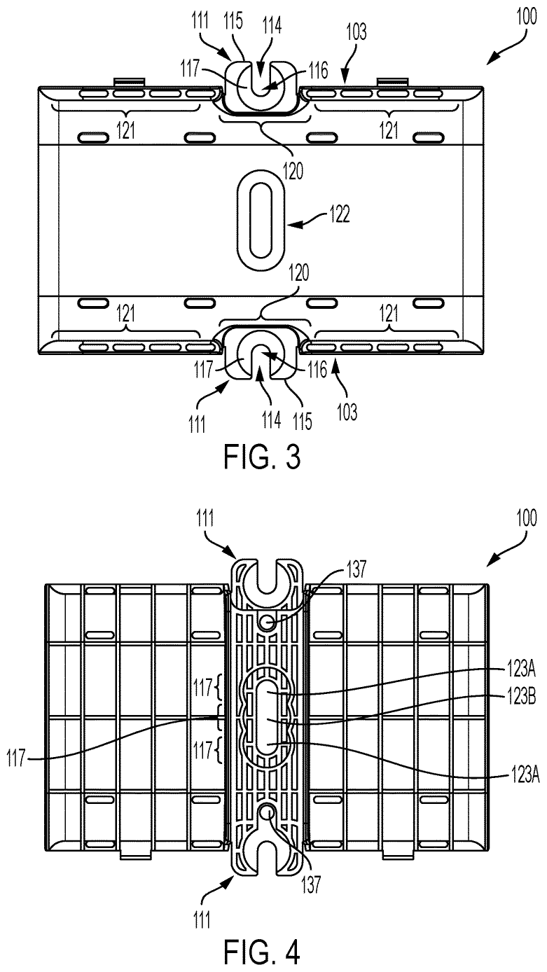

With reference to FIG. 3, each suspension rod connection tab 111 may comprise a slot 114 through an outer edge 115 thereof towards a centre 116 thereof. As such, the suspension rods 112 may be brought in sideways to engage the suspension rod connection tabs 111 as opposed to having to insert the suspension rod longitudinally into the connection tab 111.

Each suspension rod connection tab 111 may further comprise a washer recess 117 coaxial with the centre 116. As is evident from FIGS. 9 and 10, a washer 118 may be clamped into the recess 117 to prevent the suspension rod 112A from sliding out of the slot 114.

According to the preferred configuration shown in FIGS. 9 and 10, each suspension rod 121 comprises a pair of hex nuts 119 bearing oppositely against respective washers 118. Furthermore, each connection tab 111 preferably comprises a washer recess 117 both on upper and lower surfaces thereof. As such, as the nuts 119 are tightened, the washers 118 bear oppositely against the respective recesses 117 to firmly connect the suspension rod 112A to the respective connection tab 112.

According to this configuration, the nuts 119 may be turned along threading of the suspension rod 112 to adjust the vertical offset of the bracket 100 with respect to the suspension rods 112.

As is best shown in FIG. 3, in top cross section, the suspension rod connection tabs 111 may be laterally recessed within vertical passageways 120 bisecting side wall portions 121 of the sides 103 which allow the suspension rods 112 to be connected close to the pipe channel 104 and further allow for compact positioning of adjacent brackets 100. As is evident from FIG. 3, the washers 118 and the suspension rods 112 may locate within the sides 103 of the bracket 100.

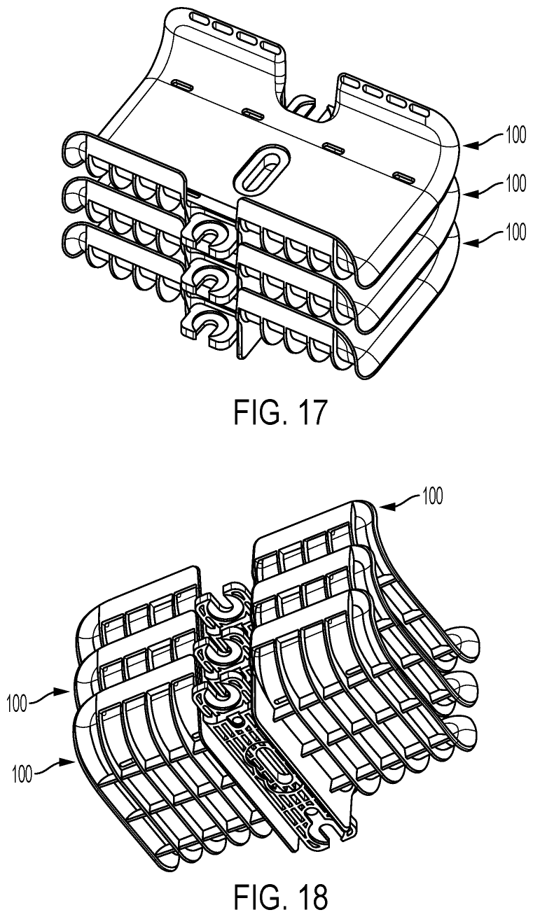

This configuration also allows the stacking of brackets 100 as is illustrated in FIGS. 17 and 19. Specifically, each connection tab 111 is configured to fit within a vertical passageway 120 of another bracket 100 thereunderneath. In this way, a plurality of brackets 100 may be compactly stacked for stowage, packaging transportation or the like.

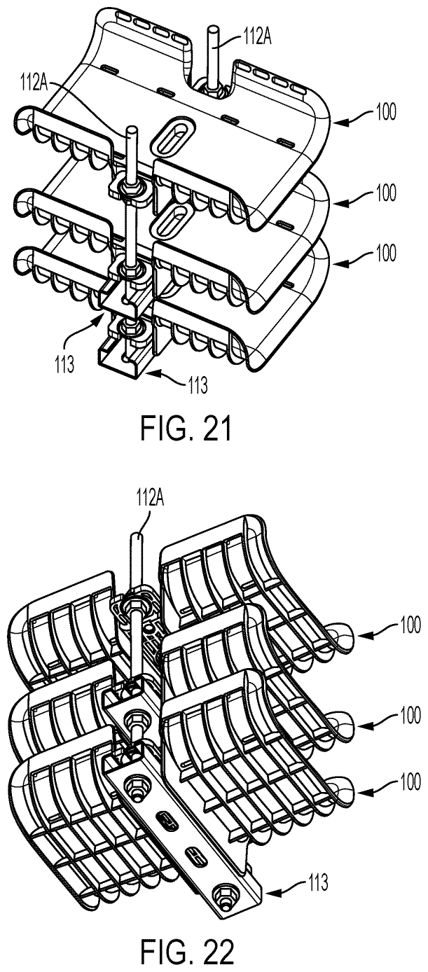

The suspension rod connection tabs 111 allow for a vertical installation of brackets 100 with common suspension rods 112A as is illustrated in FIGS. 21 and 22. Specifically, the connection tabs 111 allow direct connection to a pair of common suspension rods 112A and the vertical passageways 112 allow the common suspension rods 112A to compactly run therethrough to vertically adjacent brackets 100.

In the embodiment shown in FIGS. 21 and 22, three brackets 100 are stacked using a common pair of suspension rods 112A.

Furthermore, the vertical offset between the bracket 100 may vary. As is shown, the upper bracket 100 may allow a greater vertical offset from the bracket 100 immediately thereunderneath as compared to between the two lowermost brackets 100 to accommodate pipes of various sizes.

Furthermore, this configuration allows for direct connection to the common suspension rods 112 alone or with reinforcement of a cross-strut 113. According to this configuration shown in FIGS. 21 and 22, the two lowermost brackets 100 are reinforced with cross-struts 113 (to suspend heavier piping for example) whereas the uppermost bracket 100 is connected directly to the common suspension rods 112 alone without a reinforcing cross-strut 113 thereunderneath.

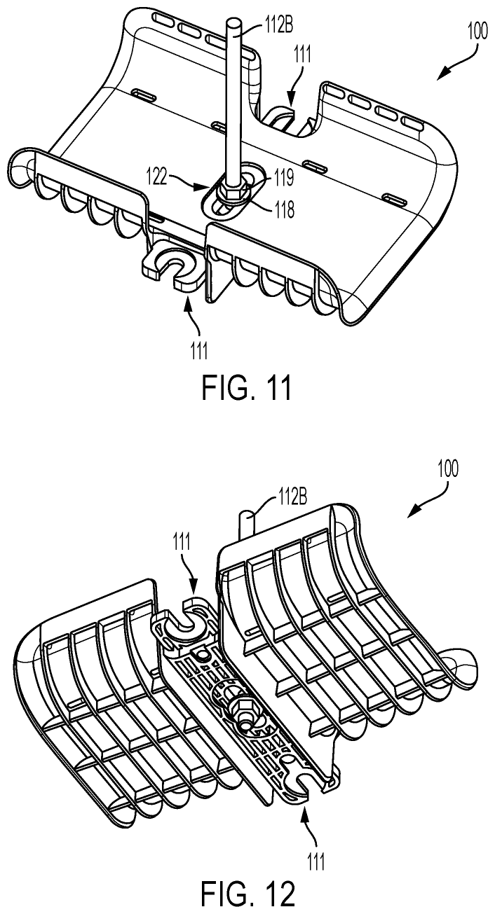

The bracket 100 further preferably comprises a central suspension rod connecting aperture 122 for suspension from a central connecting rod 112B in the manner illustrated in FIGS. 11 and 12. The central connecting rod 112B may locate between adjacent pipes held by the bracket 100.

The aperture 122 is preferably elongate and orientated across the bracket 100. With reference to FIG. 4, the central suspension rod connecting aperture 112 may comprise a plurality of washer recesses 117 each defining a respective lateral rod engagement position. In embodiment shown, the washer recesses 117 may define a central engagement position 123B and a pair of lateral engagement position is 123A.

These washer recesses 117 help exactly align a plurality of brackets 100 along a length of piping. For example, for pipework comprising a large diameter pipe and a small diameter pipe, central suspension rods 112B may be connected at a lateral engagement position 123A so that the brackets 100 exactly align along the length of the pipework.

As is illustrated in FIG. 1, the bracket 100 may be supported from the central suspension rod 112B alone. The way in which the nuts 119 clamp the washers 118 either side of the aperture 122 prevents lateral tilting of the bracket 100 with respect to the central suspension rod 112B. However, for heavier pipework, the bracket 100 may be supported by both a central suspension rod 112B and the pair of suspension rods 112A, with or without the cross-strut 113.

Even for the wider variant of the bracket 100 shown in FIGS. 7 and 8, the bracket 100 may yet only comprise a single central suspension rod connecting aperture 122.

With reference to FIG. 13, the cross-strut 113 may be metallic an comprise a web 126 with side flanges 127 having inwardly transitioning edges 128. With reference to FIG. 14, the cross-strut 113 may comprise a plurality of suspension rod engaging apertures 129 therealong, each of which may be elongate for lateral spacing tolerance.

According to FIGS. 13 and 14, the cross-strut 113 may be orientated with the web 126 positioned downwardly within the channel 125 and the inwardly transitioning edges 128 positioned upwardly within the channel 125.

The cross-strut channel forming portion 124 may be defined between a pair of side flanges 129 which may be spaced to frictionally fit the cross-strut 113 therein. Furthermore, inner surfaces of the flanges 129 may comprise ribs or other formations therein which interfere against sides of the webs 127 of the cross-strut 113.

The bracket 100 is preferably configured for arrangement in a side-by-side configuration as is shown in FIGS. 19 and 20. According to this configuration, inner connection tabs 115 of adjacent brackets 100 overlap and whereas the brackets 100 expose outer connection tabs 115 for connection to suspension rods 112A.

With reference to FIG. 6, the connection tabs 111 may be vertically offset. Specifically, as is shown in FIG. 6, the connection tabs 111 may comprise an upwardly offset connections tab 111A and a downwardly offset connection tab 111B.

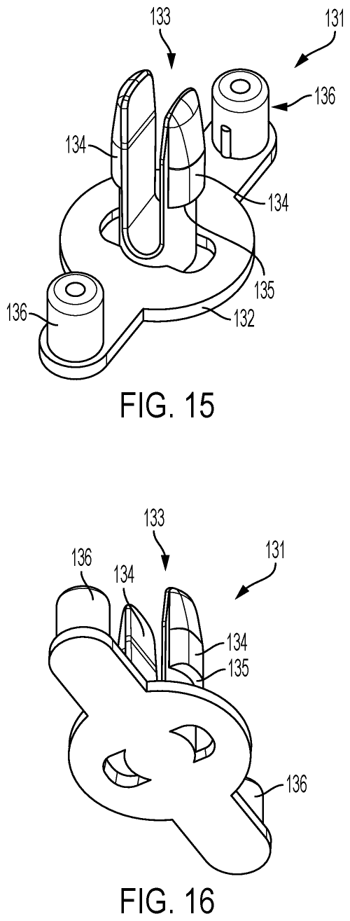

As such, when brackets 100 are placed together, the respective upwardly and a downwardly offset connection tabs 111A and 111B overlap.

Whereas a suspension rod 112 may be connected between collocating slots 114 of overlapping connection tabs 111, an embodiment employs a connector 131 as is illustrated in FIGS. 15 and 16. The connector 131 may comprise a base 132 from which a central clip 133 extends. Central clip 133 may comprise a pair of arrowhead boss bifurcated portions 134 which are shaped to close together when pressed through corresponding slots 114 of overlapping connection tabs 111 and which spring outwardly so that a lower engagement edge 135 thereof engages an upper surface of the upwardly offset connections tab 111A.

The connector 131 may further comprise a pair of protrusions 136 located either end of the base 132. With reference to FIG. 4, these protrusions go into respective apertures 137 inwardly adjacent respective connection tabs 111. The protrusions 136 and the base 132 is tensioned across the adjacent brackets 100 in opposition to orthogonal force applied by the central clip 133 to prevent bending of the overlapping connection tabs 111 in use.

As alluded to above, one side of the bracket 100 may comprise a male engagement 138 which, with reference to FIG. 6, may take the form of an upwardly transitioning hook 138. As such, an adjacent bracket 100 may be lowered onto the hook 138 of the bracket 100 wherein the hook 138 engages under the engagement edge 110 of the outer side wall 108B.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A system comprising a piping saddle bracket defining an open pipe channel, a cross strut channel across and under the pipe channel and comprising suspension rod connectors aligned with the cross strut channel, wherein, in use, the piping saddle bracket is configured to be supported by a cross strut engaged by a pair of suspension rods, wherein the cross strut is engaged in the cross strut channel and the pair of suspension rods are engaged by the suspension rod connectors.

2. The system as claimed in claim 1, wherein the piping saddle bracket is further configured to be supported in use by the cross strut alone engaged in the cross strut channel.

3. The system as claimed in claim 1, wherein the piping saddle bracket is further configured to be supported in use by the pair of suspension rods alone engaged by the suspension rod connectors.

4. The system as claimed in claim 1, wherein the piping saddle bracket comprises:
a pipe channel forming portion having a base and sides defining the open pipe channel; and
a cross strut channel forming portion defining the cross strut channel and wherein the cross strut channel forming portion defines the suspension rod connectors.

5. The system as claimed in claim 4, wherein the pipe channel forming portion and the cross strut channel forming portion are integrally formed in plastic as one piece.

6. The system as claimed in claim 1, wherein the pipe channel is configured to fit more than one pipe adjacently.

7. The system as claimed in claim 6, wherein, in end cross section, a base of the pipe channel defines a planar surface.

8. The system as claimed in claim 7, wherein, in end cross section, the pipe channel defines a curvature having a radius between the base and sides thereof and wherein a width between the sides is four times the radius or more.

9. The system as claimed in claim 7, wherein the pipe channel has a width twice its depth or more.

10. The system as claimed in claim 1, wherein each suspension rod connector has an insertion slot.

11. The system as claimed in claim 10, wherein each suspension rod connector comprises a washer recess intersecting the slot.

12. The system as claimed in claim 1, wherein, in top cross section, the suspension rod connectors intersect respective vertical passageways bisecting sides of the piping saddle bracket.

13. The system as claimed in claim 12, wherein the suspension rod connectors are configured to fit within respective vertical passageways of a another vertically stacked piping saddle bracket.

14. The system as claimed in claim 1, further comprising the pair of suspension rods and a further piping saddle bracket vertically offset from the piping saddle bracket and wherein suspension rod connectors of the piping saddle bracket and the further piping saddle bracket simultaneously engage the suspension rods.

15. The system as claimed in claim 1, further comprising a plurality of further piping saddle brackets having their suspension rod connectors simultaneously engaged by the suspension rods and wherein the piping saddle brackets are nonuniformly vertically offset.

16. The system as claimed in claim 1, further comprising a central suspension rod connection aperture through a base of the pipe channel.

17. The system as claimed in claim 16 wherein the aperture is elongate and orientated across the base.

18. The system as claimed in claim 17, wherein the aperture comprises a plurality of washer recesses adjacently formed therealong, each defining a respective suspension rod engagement position.

19. The system as claimed in claim 16, further comprising a central suspension rod and wherein the suspension rod is connected to the piping saddle bracket by the central suspension rod connection aperture.

20. The system as claimed in claim 19, further comprising a pair of pipes within the pipe channel and wherein the central suspension rod is between the pipes.

21. The system as claimed in claim 19, wherein the plurality of washer recesses define a central rod engagement position and lateral rod engagement positions and wherein the central suspension rod is connected at one of the lateral rod engagement positions.

22. The system as claimed in claim 19, wherein the piping saddle bracket is further configured to be suspended solely by the central suspension rod.

23. The system as claimed in claim 4, wherein the cross strut channel is defined between a pair of flanges.

24. The system as claimed in claim 23, wherein the flanges of the cross strut channel forming portion are configured to frictionally engage the cross strut.

25. The system as claimed in claim 1, wherein each suspension rod comprises an upper nut above a respective suspension rod connector and a lower nut beneath the cross strut.

26. The system as claimed in claim 1, wherein the suspension rod connectors are configured to interface suspension rod connectors of an adjacent piping saddle bracket in use.

27. The system as claimed in claim 26, wherein the suspension rod connectors are vertically offset with respect to each other to overlap with the suspension rod connectors of the adjacent piping saddle bracket in use.

28. The system as claimed in claim 26, wherein a pipe channel forming portion forming the open pipe channel is configured so that sides of the adjacent piping saddle brackets contact each other.

29. The system as claimed in claim 28, wherein the sides comprise interlocking engagements.

30. The system as claimed in claim 26, further comprising the adjacent piping saddle bracket and wherein the pair of suspension rods are connected to outer suspension rod connectors of the piping saddle bracket and the adjacent piping saddle bracket.

31. The system as claimed in claim 26, further comprising the adjacent piping saddle bracket and a connector configured to inner interconnect suspension rod connectors between the piping saddle bracket and the adjacent piping saddle bracket.

32. The system as claimed in claim 31, wherein the connector comprises a base, a central clip extending from the base configured to clip through collocating openings of the inner suspension rod connectors and a pair of protrusions spaced apart from ends of the base configured to engage respective apertures of the inner suspension rod connectors.
